(19) United States
(12) Patent Application Publication
(10) Pub. No.: US 2005/0281652 A1
(43) Pub. Date: Dec. 22, 2005

(54) Portable tilting container loader

(76) Inventors: Richard Arnold Riley, Christchurch (NZ); Andrew Rhodes, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/109,242

(22) Filed: Apr. 18, 2005

(30) Foreign Application Priority Data
Apr. 16, 2004 (NZ) 532375

(51) Int. Cl. B60P 1/64

(52) U.S. Cl. 414/498

(57) ABSTRACT

A portable tipping apparatus 1 for tipping a shipping container 20 for loading includes a base 3 adapted to rest upon a supporting surface and a tipping platform 6 mounted on the base with fasteners 10 for securing the container thereto. Actuators 7 tilt the tipping platform 6 to raise an opening end of the container for loading the container with bulk product. Four fittings 41 fixed to the base 3 in a rectangular array are provided to receive twist locks for securing the apparatus 1 in transport. A door-control device 44 mounted on the tipping platform 6 is operable to open or close the doors 26, 26′ of the container at any tilted position of the tipping platform 6 and includes an elongate arm 45 pivoted by an actuator 50. A block 48 sliding longitudinally on the arm 45 is fixed by a clamp 49 to the door of the container.

### CROSS-REFERENCE TO RELATED APPLICATIONS

The present patent application claims priority from New Zealand Patent Application No. 532375, filed on Apr. 16, 2004.

### TECHNICAL FIELD

The present invention relates generally to equipment for tilting containers for loading, and more specifically relates to portable systems for loading containers.

### BACKGROUND ART

In many industries, modular steel shipping containers have become a common and useful means for transporting and storing various goods and materials. These containers are typically mounted on trucks, trailers, railway wagons, and freighters for shipment. Common multi-purpose shipping containers are the standard 20′ and 40′ ISO (International Standards Organization) containers which typically have two hinged access doors closing an access opening on a front side of the container. These containers are secured during transport by four ISO corner castings at the corners of the base of the container which are engaged by four standard ISO twist locks.

Various bulk materials, such as crops, have been transported in specially made or modified shipping containers of this type. Once containerised, the products can be shipped without the opportunity for mixing with other products, without additional handling which may cause damage, loss or other deterioration. Most crops, for example, are loaded into containers using conveyors or elevators at storage or processing facilities. Different devices for use in such facilities for supporting a shipping container such that the front side is raised and the floor of the container inclined at an angle to the horizontal, allowing bulk material to be loaded through the open doors into the container. The use of these devices allows a standard container to be used without special modification such as the provision of additional access and discharge openings. When the container is inclined many bulk materials, such as crops, can flow under the action of gravity to largely fill the container. Such a machine is described in Australian Patent App. No. AU200124759 and includes a frame to which the container is fastened and actuators for tilting the frame. An inclined elevator is used to discharge product through the access opening. This machine, however, cannot readily be transported without disassembly and it includes no provision for fastening the base for transport or by which the base may be engaged for lifting. Using this machine, it is also necessary that a bulkhead is installed inside the doors at the front side of the container to allow the container to be substantially completely filled. An opening in the upper end of the bulkhead is provided for receiving the bulk material during loading. The bulkhead allows a full container to be lowered, without loss of material and without requiring the doors to be closed.

While some bulk materials have been containerised at remote sites, the lack of efficient and economical means for filling containers in such sites prevents the widespread use of containers for transporting bulk materials. Portable container tilting machines suitable for use at remote sites, such as that described in U.S. Pat. No. 6,802,686, require a specially dedicated vehicle (a truck) as does the trailer with a tipping platform described in Australian Patent App. No. AU200124759.

It is an object of the present invention to address the foregoing problems or at least to provide the public with a useful choice. Further aspects and advantages of the present invention will become apparent from the ensuing description which is given by way of example only.

Any publication cited in this specification is hereby incorporated by reference; however this does not constitute an admission that the document forms part of the common general knowledge in the art, in New Zealand or in any other country. The applicant reserves the right to challenge the pertinency of any publication cited herein, or to challenge the accuracy of any assertion made in a cited publication. As used herein, the word “comprises” means “includes, but is not limited to” and its derivatives have a corresponding meaning.

### DISCLOSURE OF THE INVENTION

According to one aspect of the present invention there is provided a portable tipping apparatus for tipping a shipping container for loading, the container having a front side with an access opening therein, the apparatus comprising:

a base adapted to rest upon a supporting surface;

a tipping member mounted on the base for engaging the container;

fasteners fixed to the tipping member for securing the container to the tipping member;

at least one actuator connected to the tipping member for tilting the tipping member to raise the opening end of the container, characterised by

four fittings fixed to the base in a rectangular array to receive twist locks for securing the apparatus to a vehicle for transport.

The base is preferably rectangular with the fittings, fixed in the corners thereof, sized and positioned to be compatible with ISO shipping containers and thereby allow the tipping apparatus to be shipped and secured with standard container handling and securing equipment. The tipping apparatus preferably includes a self-contained power pack, providing an efficient and economical means for tipping containers for filling with bulk products at any location without the necessity for providing a separate power supply. The phrase “bulk products” is used herein in a broad sense to include loose products such as crops, granular material, and the like and it may also include packaged products.

According to another aspect the invention provided apparatus further comprising a door-control device for controlling at least one hinged door which closes the access opening, the device comprising: fastening means for anchoring the device to the door;

drive means mounted on the tipping member and connected to the fastening means, and

control means for operating the drive means to open or close the door at any tilted position of the tipping member.

The fastening means may include any known fastener, but preferably is a clamp for gripping the door. The clamp preferably engages with a rod fixed to the door and which is provided for holding the door closed.

The drive means preferably includes a powered actuator connected to a mechanical linkage. Alternatively the drive means may include only an actuator connected directly to the clamp. The linkage preferably includes an elongate pivoting arm connected to the tipping member for pivoting about an axis substantially parallel to a hinge axis of the hinged door. Preferably a sliding block is connected to the pivoting arm for sliding relative to the elongate axis of thereof and the clamp is fixed to the sliding block. Preferably the actuator is a linear actuator, most preferably a hydraulic ram.

Preferably two independently operable door-control devices are provided for controlling each of two doors on the container. The control means may include a hydraulic valve positioned remotely from the tipping member for controlling flow to a hydraulic actuator.

In a preferred embodiment the tipping member is a rectangular platform pivoted about an axis extending transversely relative to the rectangular base such that with the platform generally horizontal the front side of the container is positioned above a front edge of the platform and a front edge of the base, the linkage being fixed to the front edge of the platform. In this manner, good access is provided for fastening the clamp to the door of the container before it is tipped for loading. Access for a machine, such as a bucked loader, from the front edge of the base to fill the container through the opening is also satisfactory.

The ability provided by the door-control device thus allows, for example, a container to be substantially completely filled with bulk product without the necessity for providing a bulkhead for partially closing the access opening.

Preferably the apparatus further includes transport means for discharging bulk material through the access opening into the container when tipped by the apparatus. The transport means may include any mechanical, pneumatic or hydraulic transport device for discharging bulk material into the container. Optionally the apparatus may include means for varying the height to which the transport means delivers the material to accommodate containers having varying dimensions or tilted to varying angles. In a preferred embodiment the transport means comprises a granular material elevator pivotally mounted to the base for movement between a substantially upright loading position and a transport position. Optionally, the elevator may be extendable for varying the height to which the transport means delivers the material.

The container has a rear side opposing the front side, two opposing lateral sides, a floor side and a roof side the opening end is raised to upend the container upon the opposing end. The tipping member may be adapted to tip the container through any angle and hold the container in position for loading, the container may also be upended such that floor and roof sides are generally upright and the container is supported upon the rear side.

Preferably the apparatus further includes weighing means for weighing the container. The tipping platform is preferably fastened to a sub-frame mounted on load cells fixed to the base, the load cells being operatively connected to a display indicating a weight figure. Gross container weight (product weight) may thus be measured and monitored during loading and optionally the transport means may be automatically controlled to shut off when a preset weight figure is reached.

According to another aspect of the present invention there is provided a method of loading a shipping container using the tipping apparatus substantially as described above, the container having a front end with an access opening therein and an opposing end, the method comprising:

fastening the container to the tipping member with the fastening means;

tipping the tipping member to upend the container upon the opposing end, and

loading the container in its upended position through the upwardly facing access opening.

The tipping apparatus can be used to upend the container beneath a hopper, elevator, conveyor or other bulk material supply apparatus for allowing material to be loaded into the container. The apparatus may, for example, be positioned next to an elevated loading dock, such that the loading dock is substantially level with the opening end in its upended position. In this way equipment (e.g. front-end loaders) on the loading dock are able to readily load material through the access opening. The material then drops into the container under the action of gravity or be placed into the container e.g. in the case of irregularly shaped bulk items.

This invention provides effective and efficient system for loading containers on site. With the use of the apparatus, greater utilization of shipping containers for the transport and storage of bulk products can be achieved.

### BRIEF DESCRIPTION OF THE DRAWINGS

Further aspects of the present invention will become apparent from the following description which is given by way of example only and with reference to the accompanying drawings in which:

FIG. 1a is a pictorial view of a first embodiment of the portable tipping apparatus of the present invention in a loading position;

FIG. 1b is a scrap view of a lower face of the base of the apparatus of FIG. 1a;

FIG. 2 is an exploded view of the apparatus of FIG. 1a;

FIG. 3 is a pictorial view of the apparatus of FIG. 1a in a transport position;

FIG. 4a is a pictorial view of a second embodiment of the portable tipping apparatus of the present invention showing the container doors closed;

FIG. 4b is an enlarged view of detail C of FIG. 4a;

FIG. 5a is a pictorial view of the apparatus of FIG. 4a showing the container doors open;

FIG. 5b is an enlarged view of detail D of FIG. 5a;

FIG. 6a is a pictorial view of the apparatus of FIG. 4a showing a transport position;

FIG. 6b is an enlarged view of detail A of FIG. 6a; and

FIG. 6c is a view corresponding to FIG. 6b but showing an operating position.

### BEST MODES FOR CARRYING OUT THE INVENTION

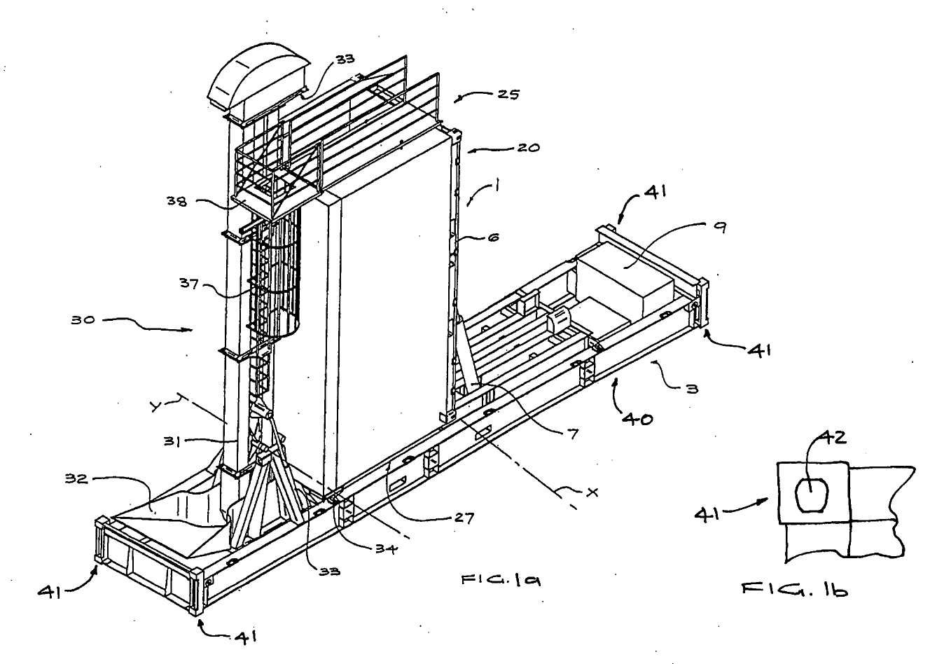

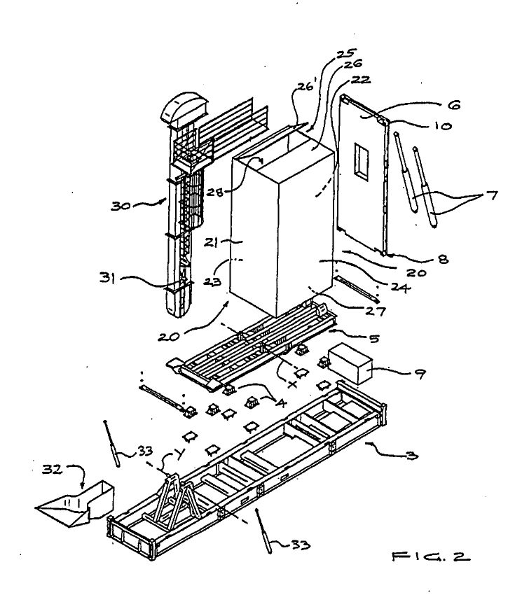

Referring to the drawings and in particular FIGS. 1a, 1b and 2, a first embodiment of a container tipping apparatus 1 of the invention generally includes a tipping member in the form of a platform 6 for tipping a shipping container 20 for loading, and a transport means or elevator assembly 30 for filling the container 20. The apparatus is used for tipping a twenty foot ISO container 20 constructed of steel having a substantially rectangular configuration including roof and floor sides 21 and 22, a pair of opposing lateral sides 23 and 24, a front side 25 (with an access opening closed by a pair front doors 26, 26′) and an opposing rear side 27 defining a compartment 28. FIG. 1 illustrates the apparatus in a loading position where the container 20 has been upended upon the rear end wall 27 for loading through the upwardly facing access opening.

The apparatus 1 includes a rectangular and generally horizontally extending frame or base 3 having a lower face 40 presented toward the ground for supporting the apparatus 1. The base 3 is constructed to be compatible with the base of an ISO shipping container, and thus has fixed thereto four corner fittings 41 (such as corner castings) arranged in a rectangular array and having an aperture 42 for receiving twist locks for securing the apparatus to a vehicle for transport or for use with standard container handling and securing equipment. Transverse openings 43 in the base 3 are provided for receiving the forks of a fork lift, or the like. The tipping apparatus 1 is thus readily portable for providing an efficient and economical means for filling and handling containers on site as required.

Fixed to the base 3 by weigh cells 4 is a sub-frame 5 to which is mounted the tipping container-engaging platform 6. The tipping platform 6 is mounted by pivots 8 to pivot about a transverse axis X through approximately 90° from a horizontal position (not shown) where the roof and floor sides 21 and 22 are horizontal to a vertical position (FIG. 1a) where the roof and floor sides 21 and 22 are upright. Optionally in other embodiments and for other applications the tipping platform 6 may be tipped through an angle of less than 90°, such that the roof and floor sides 21 and 22 are inclined to the horizontal for loading. The platform 6 is tilted by a pair of linear actuators or hydraulic cylinders 7 powered from a power pack 9. ISO twistlocks 10 in the four corners of the tipping platform 6 provide fasteners for engaging the corner castings (not shown) of the container 20 to secure the container 20 to the platform 20. When upended the container 20 is supported upon two pads 34 and is further held in this stable position by the cylinders 7.

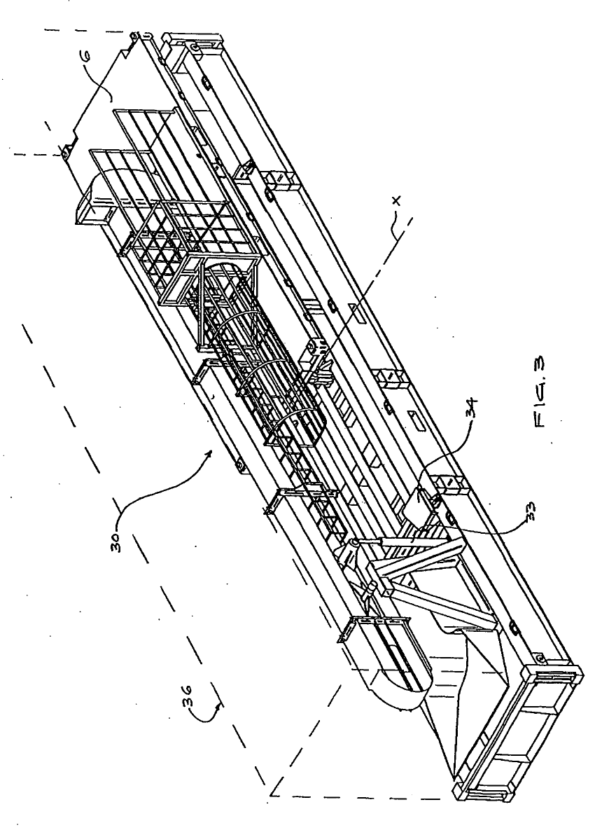

In the preferred embodiment illustrated, the apparatus further includes transport means in the form of a collapsible granular material elevator 30. The elevator 30 is mounted upon trunnions 31 for pivoting about a transverse axis Y to collapse from an upright loading position (FIG. 1a) to a substantially horizontal transport position (FIG. 3) where it lies upon the (lowered) tipping platform 6. When loading, the elevator 30 raises granular material from a hopper 32 at one end of the base 3 to a discharge outlet 33 above the open end 25 and through a nozzle (not shown) into the compartment 28. The elevator 30 is pivoted by a pair of hydraulic cylinders 7 powered from the power pack 9, which also provides operating power for elevator 30. The elevator 30 includes a ladder 37 extending to an upper platform 38 for access to the open end 25 of the upended container.

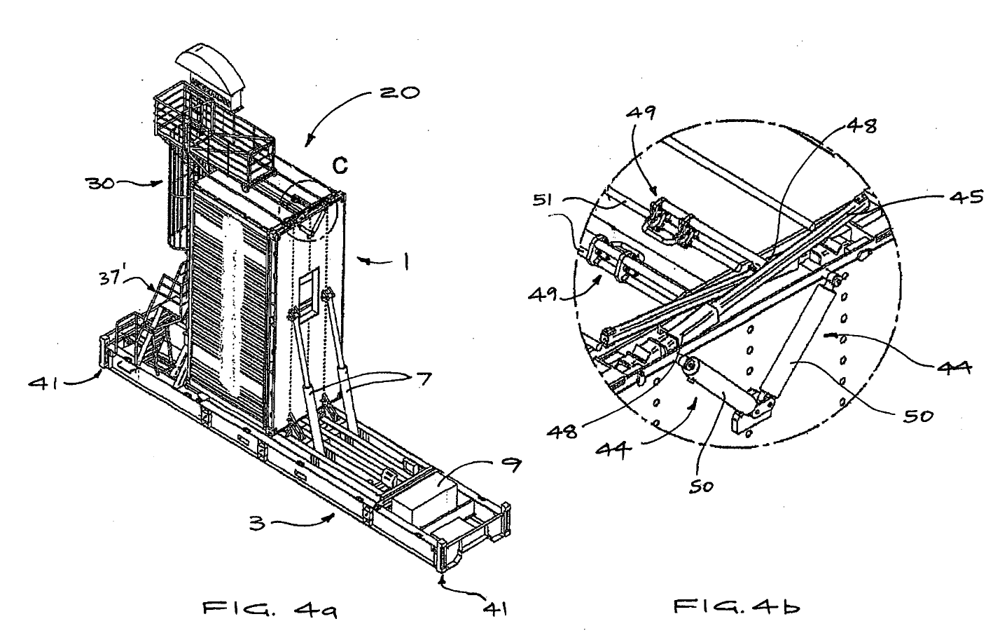

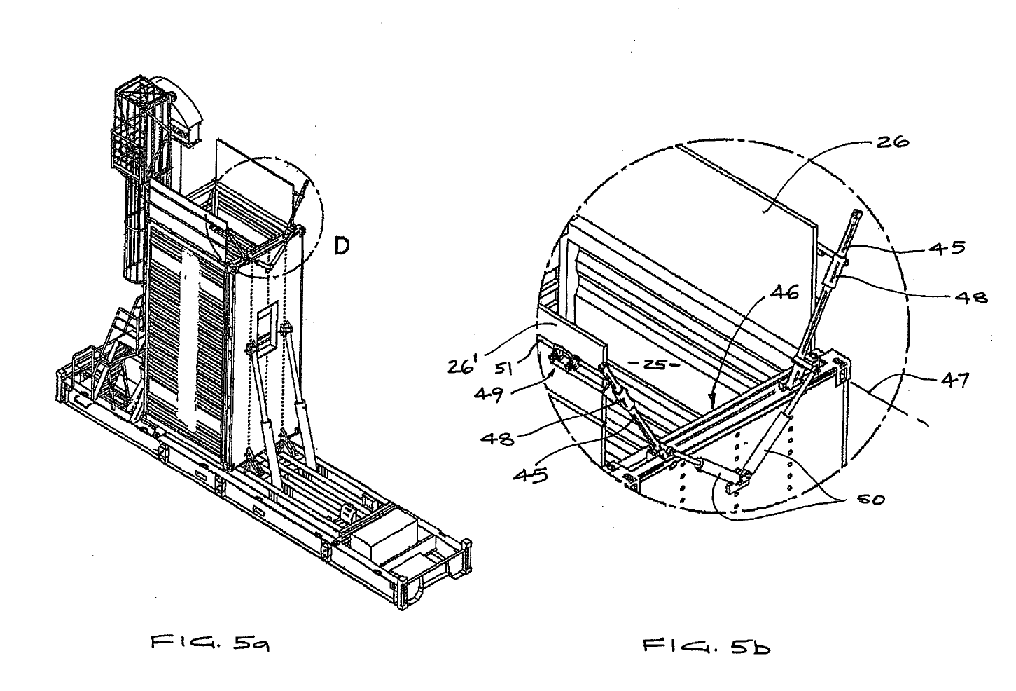

With reference to FIGS. 4a, 4b, 5a, 5b a second embodiment of the apparatus 1 includes a door-control device 44 for opening and closing each of the two doors 26, 26′. Each door-control device 44 includes a mechanical linkage with an elongate pivoting arm 45 connected to a front edge 46 of the platform 6 for pivoting about an axis substantially parallel to a hinge axis 47 of the door 26. When the floor side 22 of the container is horizontal (not shown) the front side 26 is positioned above the front edge 46 of the platform 6 and a front edge 54 of the base 3.

An over-centre clamp 49 grips the locking rod 51 used to hold the door 26 closed. A sliding block 48 fixed to the clamp 49 has an aperture (not shown) in which the pivoting arm 45 is received allowing the block 48 to slide longitudinally. A hydraulic ram 50 is pivotally connected at one end to a lower face of the platform 6 and at the other end to the pivoting arm 45. Each door-control device 44 is independently operable by means of a solenoid-operated hydraulic valve (not shown) for controlling each of two doors on the container. A remote-control unit (not shown) allows each door-control device 44 to be operated from the position of the main controls (not shown—positioned adjacent the base of the elevator 30), from the top platform 38 (e.g. when the container is vertical) or adjacent the front side 25 (e.g. when the container is horizontal).

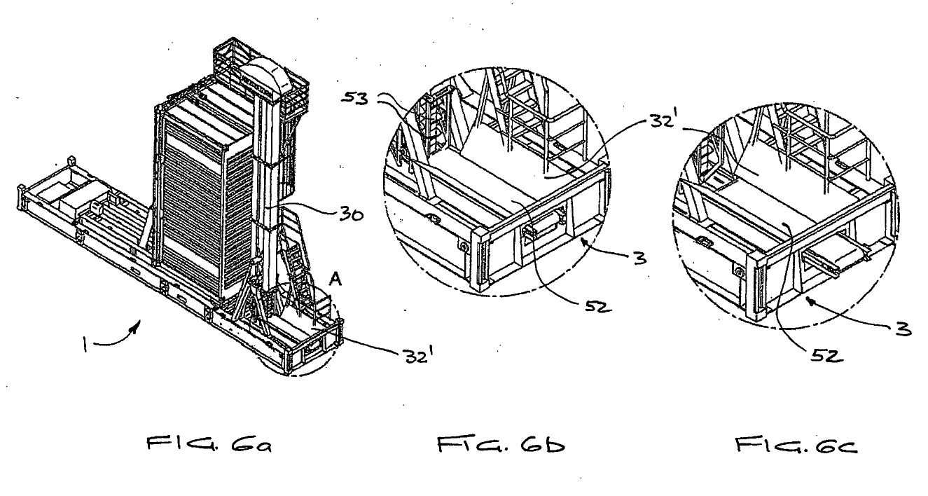

In addition to the door-control device 44, the second embodiment includes a hopper 32′ at the base of which a conveyor 52 is provided for transporting bulk material to the elevator 30. The conveyor 52 is mounted for sliding between a retracted position (FIG. 6b) for transport, wherein it is retracted within the base 3, and an extended position (FIG. 6c) wherein it is extended from the base 3. In the retracted position the end of the conveyor 52 adjacent the elevator 30 sits between buckets 53, so the conveyor 52 must be extended for use of the elevator 30.

The apparatus can be used on site, for example for loading crops. It can be transported on a vehicle having a crane, or the like, allowing the apparatus 1 to be placed in or adjacent an agricultural field during harvesting. Having its own power pack 9, the apparatus 1 is able to operate independently in remote sites (although mains power supply is also an option). After positioning the frame generally horizontally the elevator 30 is erected. A container 20 is placed on the horizontal tipping platform 6 by means of a forklift, sidelifter, crane or the like and secured by the twistlocks 8 in the four corners. The door-control device 44 is clamped to each door 26, 26′. The platform 6 is then tipped to upend the container 20 upon the rear side 27. For example, one of the doors 26 may remain closed, while door-control device 44 is operated to open the other door 26′ and fix it in a partially open position. Alternatively both doors 26, 26′ may be opened (as shown in FIGS. 5a and 5b). A crop (for example) may be fed into the hopper 32 from a harvester, such as a combine, or from a truck that in turn has been filled during the harvest operation. The weight of the container can be monitored during loading to ensure weight limits are not exceeded and so as to determine the net weight of material when the container is filled. When loading is completed the operator actuates the door-control device 44 to close the door 26′ before tipping the container 20 back upon its base 24. For transport both the tipping platform 6 and elevator are lowered to lie generally horizontally.

The elevator is designed to be readily removed from the apparatus, for uses such as filling a container beneath an existing hopper or elevator. In other embodiments not illustrated one or more loading devices, or the like, may be fixed to the apparatus.

Referring to FIG. 3, in the transport position the elevator 30 and platform 6 lie within the oblong outline 36 of a standard shipping container having a base defined by the base 3. Being within these standard dimensions the apparatus may be transported with standard handling and securing equipment without interfering with adjacent containers. While the embodiment of the invention has been illustrated with the base 3 being compatible with an ISO 40′ container and the loaded container 20 being a 20′ ISO container, it will be understood that the invention is not limited to these sizes or types of container.

Aspects of the present invention have been described by way of example only and it should be appreciated that modifications and additions may be made thereto without departing from the scope thereof.

1. A portable tipping apparatus for tipping a shipping container for loading, the container having a front side with an access opening therein, the apparatus comprising:
a base adapted to rest upon a supporting surface;
a tipping member mounted on the base for engaging the container;
fasteners fixed to the tipping member for securing the container to the tipping member; and
at least one actuator connected to the tipping member for tilting the tipping member to raise the opening end of the container, wherein
four fittings are fixed to the base in a rectangular array to receive twist locks for securing the apparatus to a vehicle for transport.

2. The tipping apparatus of claim 1 wherein the base is rectangular and the fittings are fixed in the corners of the base and sized and positioned to be compatible with ISO shipping containers.

3. The tipping apparatus of claim 1 further comprising a door-control device for controlling at least one hinged door which closes the access opening, the door-control device comprising:
fastening means for anchoring the device to the door;
drive means mounted on the tipping member and connected to the fastening means; and
control means for operating the drive means to open or close the door at any tilted position of the tipping member.

4. The tipping apparatus of claim 3 wherein the fastening means is a clamp for gripping the door.

5. The tipping apparatus of claim 3 wherein the drive means includes a powered actuator connected to a mechanical linkage.

6. The tipping apparatus of claim 5 wherein the linkage includes an elongate pivoting arm connected to the tipping member for pivoting about an axis substantially parallel to a hinge axis of the hinged door, a sliding block is connected to the pivoting arm for sliding relative to the elongate axis of thereof and the clamp is fixed to the sliding block.

7. The tipping apparatus of claim 6 wherein the tipping member is a rectangular platform pivoted about an axis extending transversely relative to the rectangular base such that with the platform generally horizontal the front side of the container is positioned above a front edge of the platform and a front edge of the base, the linkage being fixed to the front edge of the platform.

8. The tipping apparatus of claim 1 further comprising transport means for discharging bulk material through the access opening into the container when tipped by the apparatus.

9. The tipping apparatus of claim 8 wherein the transport means comprises a granular material elevator pivotally mounted to the base for movement between a substantially upright loading position and a transport position.

10. The tipping apparatus of claim 1 wherein the tipping member is fastened to a sub-frame mounted on load cells fixed to the base, the load cells being operatively connected to a display indicating a weight figure.

11. The tipping apparatus of claim 3 comprising two independently operable door-control devices for controlling each of two doors on the container.

12. Apparatus for tipping a shipping container for loading, the container having a front side with an access opening therein closable by a pair of hinged doors, the apparatus including:
a base adapted to rest upon a supporting surface;
a tipping member mounted on the base for engaging the container;
fasteners fixed to the tipping member for securing the container to the tipping member;
at least one tilting actuator connected to the tipping member for tilting the tipping member to raise the opening end of the container;
two independently operable door-control devices for controlling each of the doors, each door-control device comprising:
an elongate pivoting arm connected to the tipping member for pivoting about an axis substantially parallel to a hinge axis of the respective door;
a door-control actuator for pivoting the arm;
a sliding block connected to the pivoting arm for sliding relative to the elongate axis of thereof;
a clamp fixed to the sliding block for gripping the respective door; and
control means for controlling the door-control actuator to open or close the door at any tilted position of the tipping member.

13. A tipping apparatus for tipping a shipping container for loading, the container having a front side with an access opening therein, the apparatus comprising:
a base adapted to rest upon a supporting surface;
a tipping member mounted on the base for engaging the container;
fasteners fixed to the tipping member for securing the container to the tipping member;
at least one actuator connected to the tipping member for tilting the tipping member to raise the opening end of the container; and
a door-control device for controlling at least one hinged door which closes the access opening, the door-control device comprising: fastening means for anchoring the device to the door; drive means mounted on the tipping member and connected to the fastening means, and control means for operating the drive means to open or close the door at any tilted position of the tipping member.

14. The tipping apparatus of claim 13 wherein the fastening means is a clamp for gripping the door.

15. The tipping apparatus of claim 13 wherein the drive means includes a powered actuator connected to a mechanical linkage.

16. The tipping apparatus of claim 15 wherein the linkage includes an elongate pivoting arm connected to the tipping member for pivoting about an axis substantially parallel to a hinge axis of the hinged door, a sliding block is connected to the pivoting arm for sliding relative to the elongate axis of thereof and the clamp is fixed to the sliding block.

17. The tipping apparatus of claim 16 wherein the tipping member is a rectangular platform pivoted about an axis extending transversely relative to the rectangular base such that with the platform generally horizontal the front side of the container is positioned above a front edge of the platform and a front edge of the base, the linkage being fixed to the front edge of the platform.

18. The tipping apparatus of claim 13 further comprising transport means for discharging bulk material through the access opening into the container when tipped by the apparatus.

19. The tipping apparatus of claim 18 wherein the transport means comprises a granular material elevator pivotally mounted to the base for movement between a substantially upright loading position and a transport position

20. The tipping apparatus of claim 13 wherein the tipping member is fastened to a sub-frame mounted on load cells fixed to the base, the load cells being operatively connected to a display indicating a weight figure.

21. The tipping apparatus of claim 13 further comprising four fittings fixed to the base in a rectangular array to receive twist locks for securing the apparatus to a vehicle for transport.

22. The tipping apparatus of claim 21 wherein the base is rectangular and the fittings, fixed in the corners of the base are sized and positioned to be compatible with ISO shipping containers.
